(19) United States
(12) Patent Application Publication
(10) Pub. No.: US 2003/0188726 A1
(43) Pub. Date: Oct. 9, 2003

(54) Combustion stabilizing device

(75) Inventors: Kenji Watanabe, Tokyo (JP); Hiroaki Saeki, Ibaraki (JP)

Correspondence Address: CROWELL & MORING LLP, INTELLECTUAL PROPERTY GROUP, P.O. BOX 14300, WASHINGTON, DC, 20044-4300, US

(73) Assignees: HITACHI, LTD.; HITACHI CAR ENGINEERING CO., LTD.

(21) Appl. No.: 10/406,247

(22) Filed: Apr. 4, 2003

(30) Foreign Application Priority Data
Apr. 8, 2002 (JP) 2002-105404

(51) Int. Cl. F02G 5/00

(52) U.S. Cl. 123/557

(57) ABSTRACT

A combustion stabilizing system including a fuel injection valve (13), and a first heater (50) and a second heater (38a, 38b) for heating a fuel sprayed from the fuel injection valve (13), the second heater using a heat source different from the heat source for the first heater (50). The first heater (50) is a PTC heater, and the second heater uses as the heat source a coolant for the internal combustion engine. The first heater vaporizes the fuel in starting the internal combustion engine, and the second heater vaporizes the fuel after warming up the internal combustion engine.

### BACKGROUND OF THE INVENTION

The present invention relates to a combustion stabilizing device which helps vaporize a fuel supplied to an automobile internal combustion engine.

Conventional combustion stabilizing devices include, for example, a fuel injection valve, a heater, and an idle speed control valve (hereinafter referred to as “ISC valve”), as described in U.S. Pat. No. 5,482,023. Such a fuel control system mixes a part of air from the ISC valve (first air flow) with a fuel from the fuel injection valve. A passage for the air from the ISC valve has an annular opening around the outlet of the fuel injection valve to mix the air and fuel. Right after mixing, the fuel from the fuel injection valve and the first air flow go into a cylindrical heater aligned downstream of the fuel injection valve. The heater has an air passage to receive another part of the air from the ISC valve. The air flowing through this air passage (second air flow) mixes, at the heater outlet, with the fuel spray flowing through the heater. Flowing through the heater helps vaporize the fuel from the fuel injection valve. Mixing at the heater outlet the fuel and the second air flow further helps vaporize the fuel.

Thus, conventional combustion stabilizing systems have a line of, from upstream to downstream, the fuel injection valve, a combining point where the fuel from the fuel injection valve mixes with the first air flow, and a mixing chamber in the heater where the fuel mixes with the second airflow. The conventional systems send the vaporized fuel directly from the heater outlet into the main air passage.

The combustion stabilizing device can help quickly start the internal combustion engine, clean up the exhaust gas, and particularly reduce the HC, by effectively helping atomize the fuel spray injected from the fuel injection valve and reduce adhesion on an intake pipe inside. Atomizing fuel spray can also stabilize the combustion.

### SUMMARY OF THE INVENTION

Conventional combustion stabilizing systems use an electrical heater (PTC heater) to vaporize the fuel when it contacts with the heater's inside, so that they need much power for the heater to fully vaporize the fuel and can only operate when the engine starts and for some minutes after starting.

Conventional combustion stabilizing systems can effectively clean up the exhaust gas in starting up the engine but cannot operate continuously during normal driving. It is thus difficult from the point of cost performance that the combustion stabilizing systems can become widely available for the internal combustion engines

The object of the present invention is to provide a combustion stabilizing system which can continuously operate and supply a vaporized fuel during driving. This can reduce harmful substances produced during driving and clean the exhaust gas more effectively.

(1) To achieve the above mentioned object, the present invention provides a combustion stabilizing device including a fuel injection valve, and a first heater for heating a fuel sprayed from the fuel injection valve, the device further comprising a second heater for heating the fuel sprayed from the fuel injection valve, the second heater using a heat source different from the heat source for the first heater.

Such a combustion stabilizing device can continuously operate and supply a vaporized fuel during driving.

(2) In the combustion stabilizing device of (1), preferably, the first heater is an electric heater, the second heater uses as a heat source heat generated from the internal combustion engine, the first heater vaporizes the fuel in starting the internal combustion engine, and the second heater vaporizes the fuel after warming up the internal combustion engine.

(3) In the combustion stabilizing device of (2), preferably, the second heater uses as a heat source a coolant for the internal combustion engine.

(4) In the combustion stabilizing device of (2), preferably, the second heater uses as a heat source an exhaust gas from the internal combustion engine.

(5) In the combustion stabilizing device of (1), preferably, the second heater has a heat source inlet and a heat source outlet at either end of a cylindrical heater passage, the inlet and outlet being positioned above and below the center axis of the heater passage such that the heat source turns around the heater passage.

(6) In the combustion stabilizing device of (1), preferably, the first heater is a PTC heater, the second heater is a coiled copper wire heating element, the first heater vaporizes the fuel in starting the internal combustion engine, and the second heater vaporizes the fuel after warming up the internal combustion engine.

(7) In the combustion stabilizing device of (1), preferably, the second heater is in contact with the first heater, and after warming up the internal combustion engine, the second heater transfers heat to the first heater so that the second heater also vaporizes the fuel.

### BRIEF DESCRIPTION OF THE DRAWINGS

FIG. 1 shows a system configuration of an internal combustion engine using the combustion stabilizing device according to the first embodiment of the present invention.

FIG. 2 shows a cross sectional view of the combustion stabilizing device according to the first embodiment of the present invention.

FIG. 3 shows a perspective view of the combustion stabilizing device according to the first embodiment of the present invention.

FIG. 4 shows a system configuration of an internal combustion engine using the combustion stabilizing device according to the second embodiment of the present invention.

FIG. 5 shows a cross sectional view of the combustion stabilizing device according to the second embodiment of the present invention.

FIG. 6 shows a perspective view of the combustion stabilizing device according to the second embodiment of the present invention.

FIG. 7 shows a cross sectional view along the line A-A of FIG. 5.

FIG. 8 shows a cross sectional view of a relevant part of the combustion stabilizing device according to the third embodiment of the present invention.

### DESCRIPTION OF THE PREFERRED EMBODIMENTS

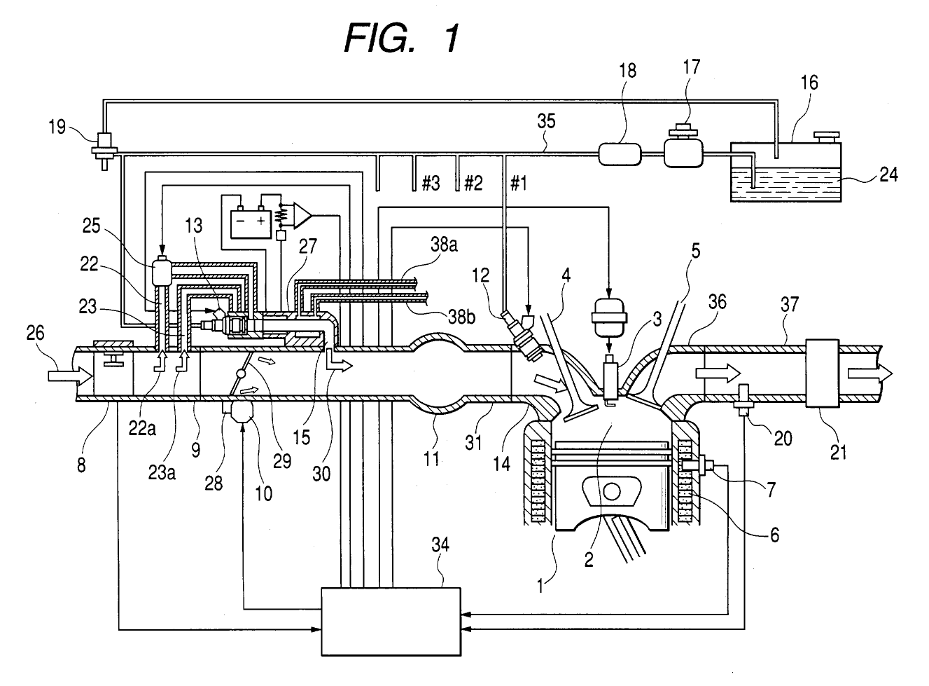

Referring to FIGS. 1 to 3, the combustion stabilizing device according to the first embodiment of the present invention will be described below.

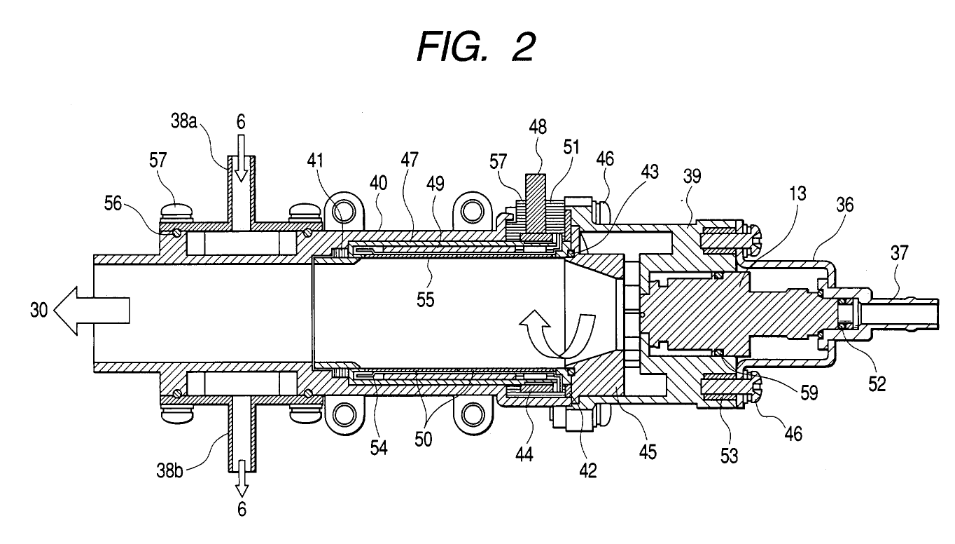

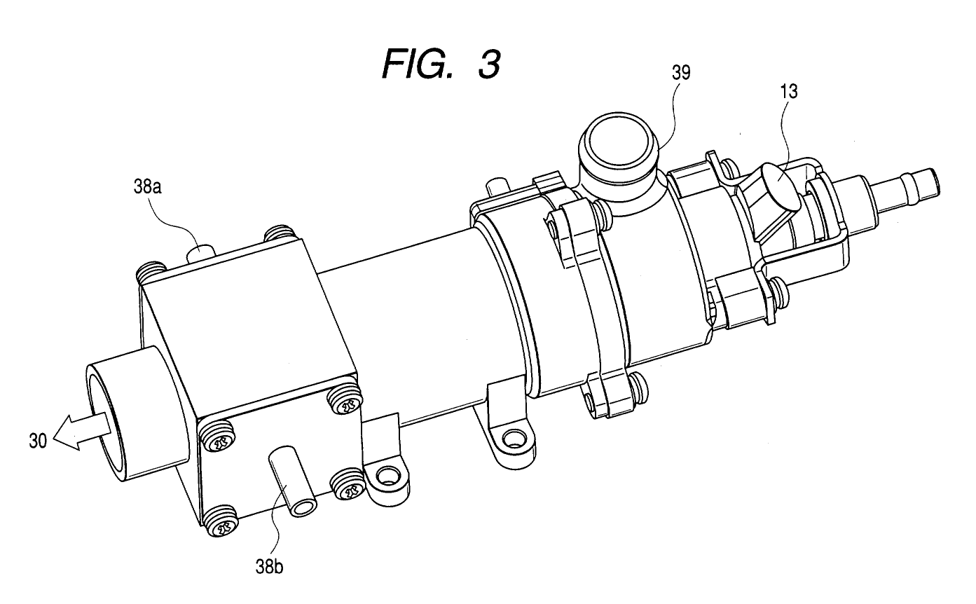

FIG. 1 is a system configuration of an internal combustion engine using the combustion stabilizing device according to the first embodiment of the present invention. FIG. 2 is a cross sectional view of the combustion stabilizing device according to the first embodiment of the present invention. FIG. 3 is a perspective view of the combustion stabilizing device according to the first embodiment of the present invention.

Referring to FIG. 1, an internal combustion engine using the combustion stabilizing device according to the present embodiment will be described. In FIG. 1, the internal combustion engine 1 is a well known ignition internal combustion engine which uses a fuel of gasoline and has a plurality of cylinders, although only one cylinder is shown in FIG. 1.

The internal combustion engine 1 includes an intake valve 4 for taking air and mixed air into a combustion chamber 2, and an exhaust valve 5 for exhausting gas after combustion. The combustion chamber 2 has an ignition plug 3. The internal combustion engine 1 includes a water temperature sensor 7 on the side of the ignition chamber 2 for detecting the temperature of an engine coolant 6, and a rotation sensor (not shown) for detecting the rotation number of the engine. Both sensors serve to detect the operating condition of the internal combustion engine 1.

An intake system for taking air into the combustion chamber 2 includes a mass air flow sensor 8 for measuring the intake air passing through an air cleaner (not shown), an electronic throttle valve 10 for electrically controlling the amount of the intake air, which can open/close and is connected to a rotating shaft which rotates in response to the driver's foot pressure on the gas pedal or to the operating condition of the internal combustion engine, a throttle positioning sensor 28, an intake manifold 11, a intake manifold branch pipe 31 which branches from the intake manifold 11 to each cylinder of the internal combustion engine 1, and intake port 14 having the intake valve 4.

A controller 34 receives flow rate data of the intake air 26 from the air flow sensor 8 and opening data of a valve 29 of the electronic throttle valve 10 from the throttle positioning sensor 28. The controller 34 use those date to detect and control the operating condition of the internal combustion engine 1.

In the present embodiment, the fuel injection system includes two types of fuel injection valves, i.e., a plurality of first fuel injection valves 12 and a single second fuel injection valve 13. The first fuel injection valve 12 connects to the intake port 14 to inject, downstream of the intake manifold 11, the fuel toward the intake valve 4 of each cylinder. The second fuel injection valve 13 connects to the combustion stabilizing device 27. A vaporizing fuel 30, which has been injected from the fuel injection valve 13 and vaporized by the combustion stabilizing device 27, goes into the intake manifold 11 through a branch passage 15 opened downstream of the electronic throttle valve 10.

A fuel supply system includes a fuel tank 16 containing a fuel 24, a fuel pump 17 delivering the fuel 24 from the fuel tank 16, a fuel filter 18, a pressure regulator 19 for regulating the pressure of the delivered fuel 24 at a predetermined value, the first fuel injection valve 12 for injecting the fuel into the intake port 14 of each cylinder (#1, #2, #3, . . . ), and the second fuel injection valve 13 supplying the fuel downstream of the throttle valve 29. All of those components connect to each other via a fuel pipe 35.

An exhaust system includes an exhaust port 36 having the exhaust valve 5 for each cylinder, an exhaust manifold 37, an oxygen concentration sensor 20 for measuring oxygen concentration in the exhaust gas, a three way catalytic converter 21 for cleaning the exhaust gas, and a dissipative muffler (not shown). The controller 34 receives the oxygen concentration data from the oxygen concentration sensor 20 to use them to detect and control the operation condition of the internal combustion engine 1. The three way catalytic converter 21 can clean the NOx, CO, and HC at a high cleanup rate at the same time which are exhausted from the internal combustion engine 1 operated nearly at a theoretical air-fuel ratio.

The combustion stabilizing device 27 connects to the branched passage 15 opened downstream of the electronic throttle valve 10. To send air measured by the mass air flow sensor 8 to the combustion stabilizing device 27, bypass manifolds 22, 23 branch from the intake pipe 9 to bypass the electronic throttle valve 10 from upstream to downstream. The bypass manifold 22 can pass carrier air 22a which carries the fuel 24 injected from the second fuel injection valve 13. An idle speed control valve 25 on the bypass manifold 22 controls the air flow rate through the bypass manifold 22. The bypass manifold 23 can pass air-assist air 23a which helps atomize the fuel 24 injected from the second fuel injection valve 13. The branch passage 15 emits the vaporizing fuel 30.

The combustion chamber 2 receives a mixed gas of the intake air 26 and the fuel 24 injected from the fuel injection valves 12 and 13. The received mixed gas is compressed and ignited by the spark plug 3 to start the combustion. The exhaust gas from the internal combustion engine 1 will escape into the atmosphere through the exhaust system.

Referring to FIGS. 2 and 3, the combustion stabilizing device 27 according to the present embodiment will be described.

As shown in FIG. 2, the combustion stabilizing device 27 includes a body 39 and a heater body 40. The body 39 is primarily provided with a second fuel injection valve 13 and a carrier air feed pipe 37. The bypass manifold 22 connects to the carrier air feed pipe 37 and will send the carrier air 22a shown in FIG. 1 through the pipe 37. The fuel pipe 37 and a fuel pipe holding member 36 fasten the fuel injection valve 13 on the body 39. The fuel injection valve 13 receives the fuel 24 through the fuel pipe 35 delivered by the fuel pump 17 from the fuel tank 16 shown in FIG. 1.

The heater body 40 has a first heater and a second heater as described hereinafter. The first heater is the same as the conventional ones. The second heater is an additional one according to the present embodiment. The heater body 40 has a positive electrode 48 and a negative electrode (body earth) to power the first heater. The second heater is provided on the outside of the heater body 40 and receives the engine coolant 6 shown in FIG. 1. The fuel vaporizes in the heater body 40 and leaves the combustion stabilizing device 27 as the vaporizing fuel 30.

The first heater in the heater body 40 includes a plate-like heater 50 around the outside of a sub passage heat transfer tube 55. The heater 50 is a ceramic heater and has upper and lower plane electrodes which heat up when current passes through them. The heater 50 of a heating element uses a PTC (Positive Temperature Coefficient Thermistor) heater which, at temperatures greater than or equal to a predetermined value, can rapidly increase its resistance to decrease the current through it and keep its temperature constant.

PTC heater 50 fastens against the positive electrode 54 and the heat transfer tube 55 which forms the negative electrode and a sub passage. A heater guide 47 holds the positive electrode plate 54 such that a rubber elastic body 49 always presses the electrode plate 54 against the PTC heater 50. The positive electrode plate 54 connects via a ring electrode 44 to the positive electrode terminal 48 outside the heater body 40. The electrically conductive heat transfer tube 55 presses on the metal heater body 40. The insulating heater guide 47 and insulating cover 51 isolate the electrodes 54, 48. When current passes through the electrode 48 and heater body 40, the heater 50 heats up to heat the transfer tube 55.

Seal rings 41, 42, and O-ring 43 seal the sub passage heat transfer tube 55 from the internal passage. A mixer 43 and the body 39 press the seal ring 42 and O-ring 43 to seal these rings. The mixer 45 is positioned such that O-rings 43, 44 can seal the internal passage.

The second heater introduces the coolant 6 into a hot water passage enclosed with a cover that forms hot water pipes 38a and 38b around the outside of the heater body 40 and that presses a seal ring 56. The hot water pipes 38a, 38b connect to piping for the engine coolant 6 shown in FIG. 1. After the internal combustion engine warms up, the temperature of the coolant raises to, for example, 80° C. The second heater uses the warmed coolant as a heat source to help vaporize the fuel sprayed from the fuel injection valve 13. Thus, the second heater needs no electricity or power unlike the PTC heater in the first heater so that the second heater can operate continuously during driving.

In the present embodiment, when the engine starts up and before it warms up, the first heater can vaporize the fuel injected from the second fuel injection valve 13 and send it through the biased passage 15 as the vaporizing fuel 30 into the intake manifold 11.

After the engine warms up, the engine coolant 6 always heats the heater body 40 to about 80° C. Thus, the second heater can vaporize the fuel and send it through the biased passage 15 as the vaporizing fuel 30 into the intake manifold 11. The second heater body 60 is in contact with the heat transfer tube 55 of the first heater so that the heat can conduct from the body 60 to the heat transfer tube 55. Thus, the second heater can always preheat the first heater to reduce the inrush current at turn-on. Additionally, after the engine warms up, the second heater can vaporize the fuel from the second fuel injection valve 13 without powering the first heater.

As described above, according to the present embodiment, the first heater helps vaporize the sprayed fuel when the engine starts up, while the second heater helps vaporize the sprayed fuel after the engine warms up. Thus, the combustion stabilizing system can continuously operate and supply a vaporized fuel during driving and reduce harmful substances produced during driving and clean the exhaust gas more effectively.

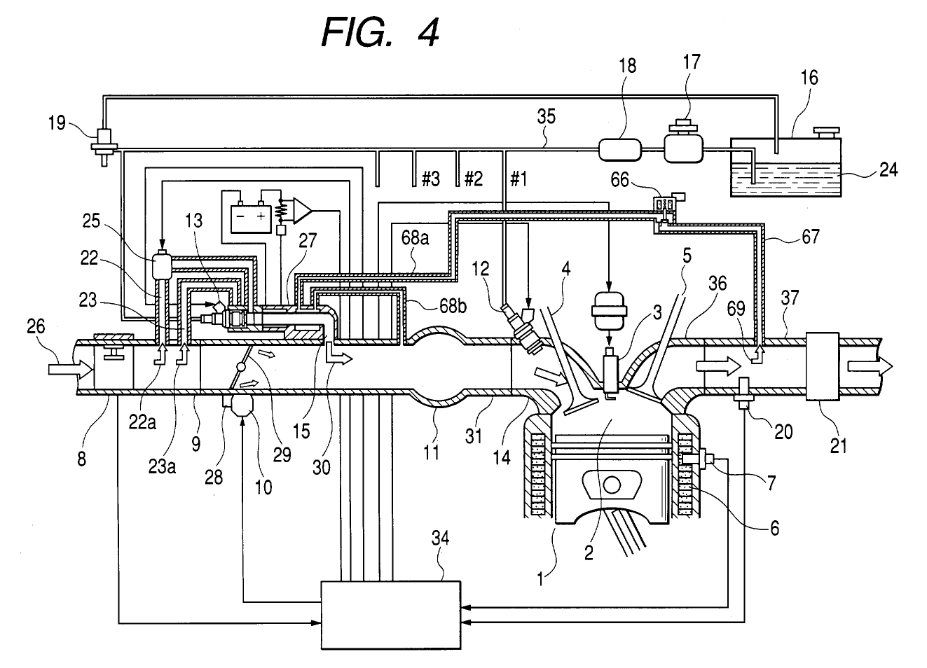

Referring to FIGS. 4 to 7, the combustion stabilizing device according to the second embodiment will be described.

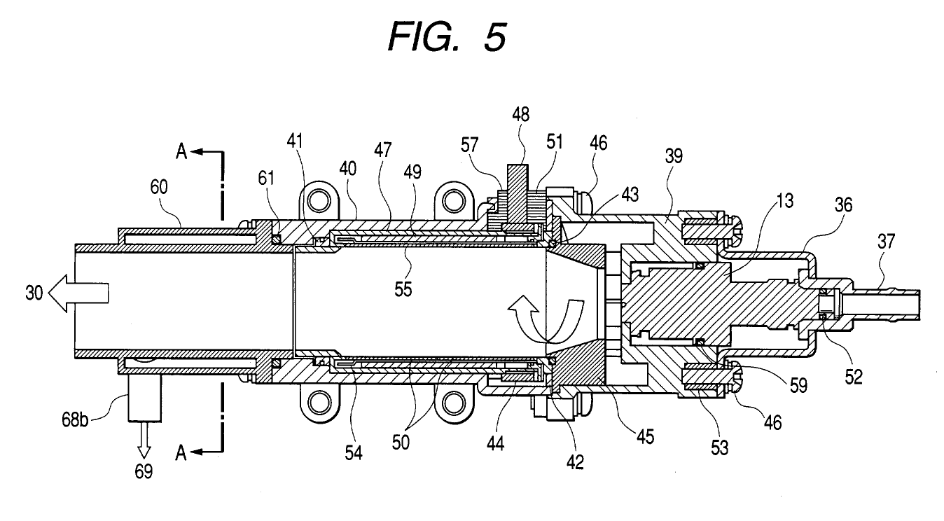

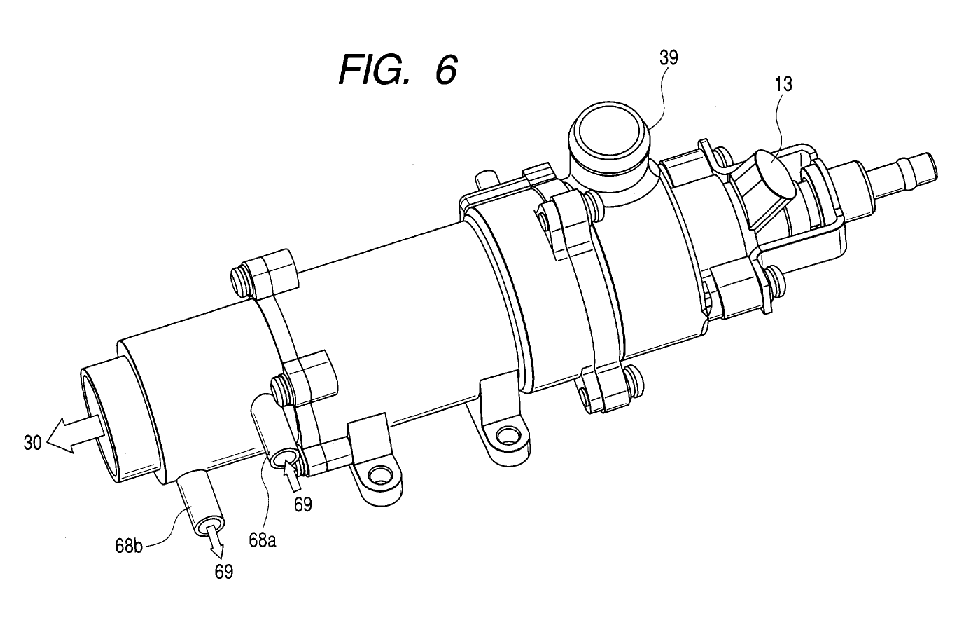

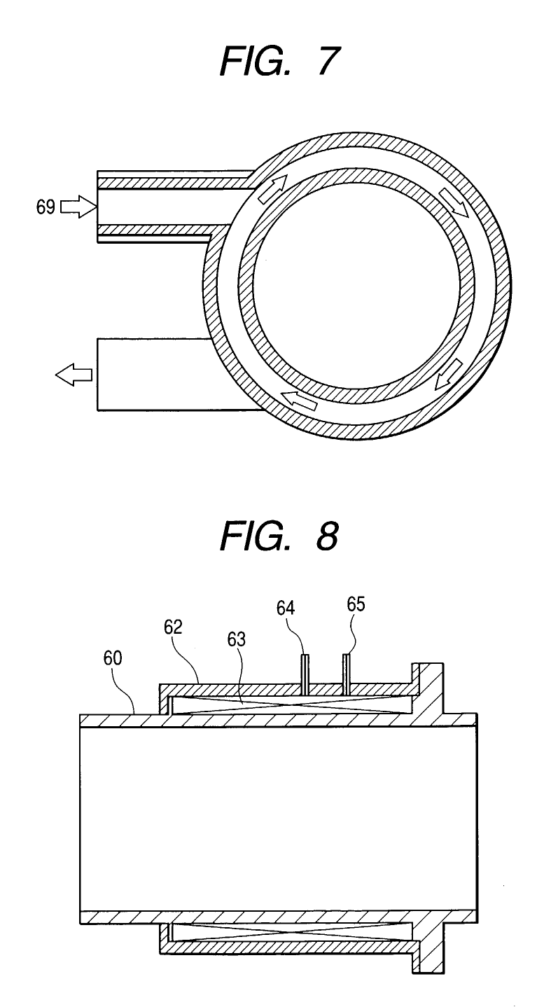

FIG. 4 is a system configuration of an internal combustion engine using the combustion stabilizing device according to the second embodiment of the present invention. FIG. 5 is a cross-sectional view of the combustion stabilizing device according to the second embodiment of the present invention. FIG. 6 is a perspective view of the combustion stabilizing device according to the second embodiment of the present invention. FIG. 7 is a cross sectional view along the line A-A of FIG. 5. The same numbers refer to the same elements of FIGS. 1 to 3.

Referring to FIG. 4, the whole configuration of an internal combustion engine using the combustion stabilizing device according to the present embodiment will be described. Most of the configuration is similar to that shown in FIG. 1 so that the difference from the first embodiment in FIG. 1 will primarily be described.

In the present embodiment, a somewhat different second heater and a different exhaust recycling system are provided. As shown in FIG. 4, the internal combustion engine with an exhaust recycling system includes an exhaust recycling passage 67 for recycling the exhaust gas from the exhaust pipe 37 to the intake pipe 31. An exhaust recycling control valve 66 controls the flow rate of the recycled exhaust gas 69.

In the present embodiment, a pipe 68a downstream of the exhaust recycling control valve 66 connects to the second heater of the combustion stabilizing device 27 and sends a hot exhaust gas into the second heater. When the exhaust recycling control valve 66 opens, negative pressure in the intake manifold 11 sucks the recycled exhaust gas 69 through the exhaust pipe 37 into the second heater body 60 shown in FIG. 5. The second heater uses as a heat source the exhaust gas which enters the heater. The exhaust gas which enters the heater then goes through a pipe 68b into the intake manifold 11, completing the original exhaust gas recycling. In other words, in the conventional exhaust gas recycling loop, the second heater receives the recycled exhaust gas and use it as a heat source to help vaporize the fuel.

Referring to FIG. 7, the flow of the recycled exhaust gas 69 through the second heater body 60 will be described. The second heater body 60 has pipes 68a and 68b, the axes of which do not intersect with the center axis of the second heater body 60. Thus, the recycled exhaust gas 69 flows around circumferentially as indicated by the open arrows in FIG. 7 so that the heat can conduct uniformly inside the second heater body 60. The second heater body 60 is in contact with the heat transfer tube 55 of the first heater so that the heat can conduct from the body 60 to the heat transfer tube 55. Thus, the second heater can always preheat the first heater to reduce the inrush current at turn-on. Additionally, after the engine warms up, the second heater can vaporize the fuel from the second fuel injection valve 13 without powering the first heater.

The configuration in which the axes of the pipes on the second heater body do not intersect with the center axis of the second heater body as shown in FIG. 7 can apply to the hot water pipes 38a and 38b in the first embodiment.

The heat source for the second heater is the coolant in the first embodiment and the exhaust gas in the second embodiment. Other heat sources such as engine oil heated after the warm-up, however, can be introduced into the second heater.

As described above, according to the present embodiment, the first heater helps vaporize the sprayed fuel when the engine starts up, while the second heater helps vaporize the sprayed fuel after the engine warms up. Thus, the combustion stabilizing system can continuously operate and supply a vaporized fuel during driving and can reduce harmful substances produced during driving and clean the exhaust gas more effectively.

Referring to FIG. 8, the combustion stabilizing device according to the third embodiment will be described.

The system configuration of an internal combustion engine using the combustion stabilizing device according to the present embodiment is the same as that in FIG. 1. The cross sectional view of the combustion stabilizing device according to the present embodiment is the same as that in FIG. 2. The present embodiment has a different configuration of the second heater, which will be described below referring to FIG. 8.

FIG. 8 is a cross sectional view of a relevant part of the combustion stabilizing device according to the third embodiment of the present invention. The same numbers refer to the same elements of FIG. 5.

As shown in FIG. 8, the second heater winds a coiled copper wire 63 around the metal second heater body 60 which forms the heat transfer tube for the fuel vaporization. Plastic resin 62 covers the outside of the wire 63 to thermally insulate it. The copper wire 63 with voltage applied across the ends 64, 65 will heat up.

The heated copper wire will increase its resistance to reduce the current through it. The generated heat will conduct outside of the coil to reduce the coil temperature. Thus, the constant voltage applied across the ends 64, 65 of the copper wire 63 allows the second heater to keep a constant temperature at which the heating balances with the heat conduction

The second heater using the copper wire 63 can heat up less quickly than the first heater using the PTC heater. The second heater, however, can keep the heater temperature constant with less power consumption than the first heater using the PTC heater.

The second heater body 60 is in contact with the heat transfer tube 55 of the first heater so that the heat can conduct from the body 60 to the heat transfer tube 55. Thus, the second heater can always preheat the first heater to reduce the inrush current at turn-on. Additionally, after the engine warms up, the second heater can vaporize the fuel from the second fuel injection valve 13 without powering the first heater.

As described above, according to the present embodiment, the first heater helps vaporize the sprayed fuel when the engine starts up, while the second heater helps vaporize the sprayed fuel after the engine warms up. Thus, the combustion stabilizing system can continuously operate and supply a vaporized fuel during driving and can reduce harmful substances produced during driving and clean the exhaust gas more effectively.

The present invention can provide a combustion stabilizing system which can continuously operate and supply a vaporized fuel during driving:

What is claimed is:

1. A combustion stabilizing device comprising:
g a fuel injection valve;
a first heater for heating a fuel sprayed from said fuel injection valve; and
a second heater for heating the fuel sprayed from said fuel injection valve, said second heater using a heat source different from the heat source for said first heater.

2. A combustion stabilizing device according to claim 1,
wherein said first heater is an electric heater,
said second heater uses as a heat source heat generated from the internal combustion engine,
said first heater vaporizes the fuel in starting up the internal combustion engine, and
said second heater vaporizes the fuel after warming up the internal combustion engine.

3. A combustion stabilizing device according to claim 2,
wherein said second heater uses as a heat source a coolant for the internal combustion engine.

4. A combustion stabilizing device according to claim 2,
wherein said second heater uses as a heat source an exhaust gas from the internal combustion engine.

5. A combustion stabilizing device according to claim 1,
wherein said second heater has a heat source inlet and a heat source outlet at either end of a cylindrical heater passage, said inlet and outlet being positioned above and below the center axis of said heater passage such that the heat source turns around said heater passage.

6. A combustion stabilizing device according to claim 1,
wherein said first heater is a PTC heater,
said second heater is a coiled copper wire heating element,
said first heater vaporizes the fuel in starting up the internal combustion engine, and
said second heater vaporizes the fuel after warming up said internal combustion engine.

7. A combustion stabilizing device according to claim 1,
wherein said second heater is in contact with said first heater, and after warming up the internal combustion engine, said second heater transfers heat to said first heater so that said second heater also vaporizes the fuel.
